(19) United States
(12) Patent Application Publication
(10) Pub. No.: US 2006/0057728 A1
(43) Pub. Date: Mar. 16, 2006

(54) Method to prevent urine specimen and other specimen substitution in substance use screening

(76) Inventors: Michael Katz, Glen Allen, VA (US); Elinore McCance-Katz, Glenn Allen, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/225,892

(22) Filed: Sep. 14, 2005

Related U.S. Application Data
(60) Provisional application No. 60/609,271, filed on Sep. 14, 2004.

(51) Int. Cl. G01N 37/00

(52) U.S. Cl. 436/56

(57) ABSTRACT

Substitution of specimens (such as urine specimens) may be detected and even prevented by adding randomization to the collection and routing of specimens. A test taker is required to ingest an ingestible entity the nature of which is concealed from the test taker and others participating in the collection of the sample. The test-taker and unauthorized personnel collecting and routing the specimen are uninformed about fluorescence behavior (or lack of fluorescence) expected for an unsubstituted specimen. The nature of the ingestible entity that a test-taker must take is randomized, and the nature of the ingestible entity is closely held, such as by using bar coding or by using a marker undetectable by the naked eye.

### RELATED APPLICATION

This application claims benefit of U.S. provisional application No. 60/609,271 filed Sep. 14, 2004 titled “Method to prevent urine specimen substitution in substance use screening.”

### FIELD OF THE INVENTION

This invention relates to specimen sample security, especially to the problem of substitution of “clean” urine samples for urine samples produced by those taking illegal or prohibited substances.

### BACKGROUND OF THE INVENTION

Specimens, especially urine specimens, are routinely taken in certain contexts, to test and monitor whether there is evidence of illegal or prohibited substance use by the person required to give the specimen. For example, urine specimens are routinely required of prisoners, probationers, and even of professional and non-professional athletes in a variety of sports contexts. Some efforts already have been made to minimize the problem of an intended specimen-giver substituting someone else's “clean” specimen for his own specimen.

Some literature relating to specimen collection is as follows.

U.S. Pat. No. 5,039,616 issued Aug. 13, 1991 to Copelan, which is herein incorporated by reference, for “Method for prevention of specimen tampering in substance abuse testing and test area relating thereto.” There is a description of administering to a subject an ingestible tagging substance to prevent substitution. All subjects ingest the same tagging substance and are continuously monitored. The amount of the tagging substance is quantitated.

U.S. Pat. No. 5,179,027 issued Jan. 12, 1993 to Fisher, which is herein incorporated by reference, for “Method employing chemical markers and kit for verifying the source and completeness of urine samples for testing the presence of drugs of abuse.” The use is described of p-amino benzoic acid or compounds containing non-radioactive isotopes.

U.S. Pat. No. 5,679,577 issued Oct. 21, 1997 to Ehrenkranz for “System for verifying the authenticity of a urine specimen utilizing levels of dissolved gases.”

U.S. Pat. No. 6,331,278 issued Dec. 18, 2001 to Copelan, for “Self-contained double handhold for preventing false urine specimens.”

U.S. Pat. No. 6,620,384 issued Sept. 16, 2003 to Copelan, for “Double handhold to prevent urine-test cheating.”

U.S. Pat. No. 6,673,621 issued Jan. 6, 2004 to Mitchell, for “Sample collection devices and methods using markers and the use of such markers as controls in sample validation, laboratory evaluation and/or accreditation.”

In conventional practice, testers generally rely on an individual assigned to witness the specimen-giving subject provide the specimen to supposedly ensure that there is no substituting of specimens. This may be embarrassing for the subject and the witness. Sometimes, a witness of the same gender as the subject is not available and the specimen cannot be properly collected.

However, in specimen collection, there remains the unsolved problem when someone in the chain of custody of the specimen becomes involved in substituting a “clean” specimen.

### SUMMARY OF THE INVENTION

The above problems and shortcomings have been addressed by the present invention. It is possible to substantially prevent substitution of specimens (such as urine specimens) by adding randomization to the collection and routing of specimens, so that the specimen-giver and unauthorized personnel collecting and routing the specimens are uninformed about whether an unsubstituted specimen is expected, for example, to fluoresce or not. (If substitution occurs, the substitution is more likely to be detected by authorized personnel where the chain of custody terminates.) The expectations of the specimen-giver and the unauthorized personnel in the chain of custody can be interfered with, for example, by lessening the level of uncoded information on the specimen-container label and by randomizing the labels on the specimen-containers. This can be accomplished, for example, by randomizing ingestible substances that the specimen-giver must ingest and by coding information on the labels of specimen containers.

Thus, the invention provides a simple, inexpensive method for verifying that a urine sample collected for illicit drug testing is a fresh urine sample provided by the subject of the urine drug test that will be reflective of that individual's current/recent substance ingestion.

The invention also provides methods that minimize the need for witnessed collection, allowing greater privacy for the individual providing the specimen and ease of specimen collection for the collection site.

In one preferred embodiment, the invention provides a method for assuring urine (or other biological) specimen authenticity while providing individual privacy, comprising the steps of: providing to an individual from which a urine (or other biological) specimen is to be procured an ingestible entity (such as, e.g., a pill, a capsule, a fluid, etc.) which is of a nature that is either a placebo or at least one detectable marker (e.g., fluorescent marker such as riboflavin), said providing step being performed in a manner where neither a provider nor the individual receiving the ingestible entity is aware of its nature; providing a mechanism for associating said nature of said ingestible entity with said individual that is provided said ingestible entity in said providing step whereby neither the provider nor the individual receiving the ingestible entity is aware of the nature of the ingestible entity from the mechanism for associating (e.g., a coding or marking system which is not discernible by the provider or person providing the specimen allows a third party testing facility to determine whether or not the person providing the specimen has ingested a placebo or a chemical marker and if a chemical marker is ingested it identifies the marker which has been ingested or its characters); confirming that the individual from which the urine specimen is to be procured ingests the ingestible entity (e.g., by observing ingestion or by other means); and then obtaining a urine specimen from the individual from which the urine specimen is to be procured; and then determining the authenticity of the urine specimen by detecting the presence or absence of said detectable marker in the urine specimen, and by determining from said mechanism for associating whether the ingestible entity ingested by the individual was a placebo or a detectable marker, said step of determining being performed by a testing authority different from said provider.

One example of a “mechanism for associating” useable in the invention is a chain of custody form which includes coded information (such as, e.g., a bar code, an RFID tag, etc.) that describes the nature of the ingestible entity (e.g., what it is or what its properties are). In inventive methods using a chain of custody form, preferably the step of determining from said mechanism for associating whether the ingestible entity ingested by the individual was a placebo or a detectable marker includes the step of determining the nature of the ingestible entity from said coded information, and wherein said ingestible entity is affixed to said chain of custody form prior to said providing to an individual step. A preferred example of a chain of custody form is a chain of custody form that includes a label of coded-information which is removable from said chain of custody form and affixable to a container used by said individual when collecting said urine specimen or the container into which a urine specimen will be transferred for later analysis which is identical to said coded information on said chain of custody form. When such a chain of custody form that includes such a label of coded information is used in an inventive method for assuring specimen authenticity, preferably there are performed the steps of: removing the label of coded information from said chain of custody form; and affixing the label of coded information to said container.

Another example of a “mechanism for associating” is a label that is attached to packaging containing said ingestible entity, said label having either a detectable marker identical to said at least one detectable marker in said ingestible entity thereon or having no detectable marker thereon. When such a label is used in an inventive method for assuring specimen authenticity, preferably the step of determining from said mechanism for associating whether the ingestible entity ingested by the individual was a placebo or a detectable marker, includes the step of determining the presence or absence of said detectable marker on said label. For example, a blacklight might be used to sense a fluorescent property on the label itself as well as in the urine specimen (i.e., if the label and specimen both fluoresce or both do not fluoresce, the specimen is likely to be authentic). A preferred example of a label is a label in the form of a removable sticker which can be affixed to a container which said individual will use for collecting and/or transporting said urine specimen. Another preferred example of a label is a label that includes a removable cover which prevents determining the nature of the label by either said provider or said individual (such as, e.g., a removable cover that is tamper resistant; a removable cover that is tamper evident; etc.).

The “mechanism for associating” may include a label that is attached to packaging containing said ingestible entity, said label having coded information that describes the nature of the ingestible entity. When such packaging and labeling is used in practicing an inventive method (e.g., a label on a blister pack, a label bar coded on plastic wrap, etc.) of ensuring specimen authenticity, preferably said step of determining from said mechanism for associating whether the ingestible entity ingested by the individual was a placebo or a detectable marker includes the step of determining the nature of the ingestible entity from said coded information on said label. Preferred examples of such a label are, e.g., a label that is in the form of a removable sticker which can be affixed to a container which said individual will use for collecting or in which the specimen will be transferred for testing by a third party; a label that includes a removable cover which prevents determining the nature of the label by either said provider or said individual (such as, e.g., a removable cover that is tamper resistant; a removable cover that is tamper evident; etc.).

The inventive methods for assuring specimen authenticity optionally may further comprise the step of providing ingestible entities which include one of a plurality of different chemical markers.

### BRIEF SUMMARY OF THE DRAWINGS

The figures are not necessarily shown drawn to scale.

FIG. 1 shows a top view of exemplary piece of paper 100 according to the invention.

FIG. 2 is an exploded view of exemplary pill packaging 220 according to the invention.

FIG. 2A is a cross-section view of part of packaging 220 showing a protectively covered label.

FIG. 3 is an exemplary schematic diagram according to the invention.

FIG. 4 shows an exemplary specimen collection system according to the invention.

### DETAILED DESCRIPTION OF A PREFERRED EMBODIMENT OF THE INVENTION

Using the present invention, it is possible to substantially prevent and/or to detect substitution of specimens (such as urine specimens) by adding randomization to the collection and routing of specimens. In the various embodiments of the invention, the test taker is required to ingest an ingestible entity the nature of which is concealed from the test taker and others participating in the collection of the specimen. The test-taker and unauthorized personnel collecting and routing the specimens are kept uninformed about, for example, fluorescence behavior (or lack of fluorescence) expected for an unsubstituted specimen (it being understood that other types of chemical markers might be used, e.g., phosphorescent, chemiluminiscent, visible color properties, etc.). The nature of the ingestible entity is randomized, with different test-takers being given ingestible entities of different nature. In each case, the nature of the ingestible entity is closely held, such as by using bar coding or by using a marker undetectable by the naked eye.

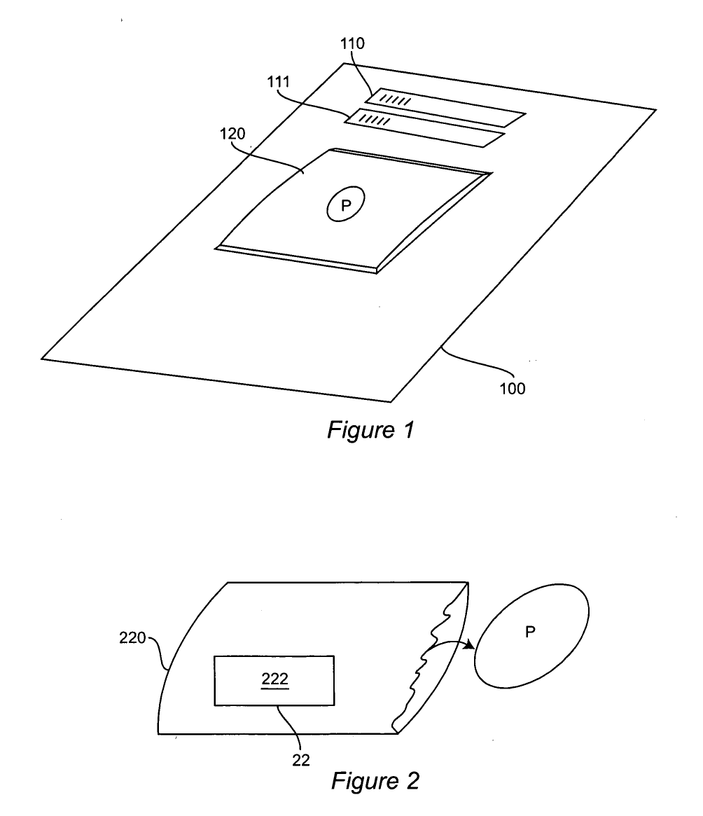

The invention in certain embodiments may be appreciated by considering FIGS. 1-4.

In FIG. 1, a piece of paper 100 (e.g., “chain of custody form”) has affixed thereto packaging 120 in which is housed a pill or capsule P. Further affixed to the paper 100 are coded information 110 and 111, with coded information 110 and 111 being duplicative of each other, and characterizing the nature of the pill or capsule P. The sizes and shapes of the coded information 110, 111, the paper 100, the packaging 120 and the pill or capsule P are shown for representation and they may be varied. At least one of coded information 110 and 111 is peelable from the paper 100 so that it may be affixed onto a specimen container (such as a urine specimen container).

The paper 100 of FIG. 1 may be used, for example, as a chain of custody form. To do so, for example, a provider having the paper 100 removes the pill or capsule P from its packaging 120 and gives the pill or capsule P to the test taker to ingest. Subsequently, a specimen container receives a sample that is intended to be the current sample of the test taker, but theoretically could be a substituted sample (such as a non-current sample of the test taker or a sample of someone other than the test taker). The urine specimen would be taken as soon after ingesting the pill or capsule as possible, but the duration will vary depending on the chemical marker. For example, 1-2 hours after ingesting a riboflavin marker should be sufficient to assure presence of the marker in the subject's urine. Onto the specimen container that is intended to be the current sample of the test taker, a peeled coded information sticker (that was coded information 110 or 111 on the paper 100) is affixed.

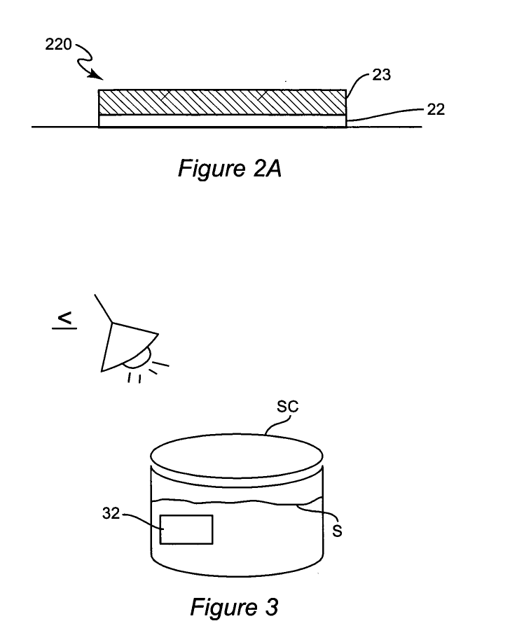

FIG. 2 depicts packaging 220 which contains pill or capsule P (which is an example of an ingestible entity) and is just being opened to remove pill or capsule P (which will be given to a test taker to ingest—it being understood that the test taker could be charged with retrieving the pill or capsule P from the packaging 220 within the practice of this invention). Packaging 220 may include a label 22 which comprises at least one detectable marker 222, and, if so, the detectable marker(s) 222 in label 22 matches any detectable marker(s) used in the pill or capsule P. (If the pill or capsule P being removed from packaging 220 is a placebo, then packaging 220 to the naked eye looks exactly like packaging 220 having a label 22 including a detectable marker 222, and the only difference is the absence of detectable marker 222, which is not a difference that is detectable by naked eye.) It should be appreciated that in the preferred embodiment pill packaging having a label 22 including at least one detectable marker 222 is indistinguishable to the eye from a packaging in which the pill is a placebo and there is therefore no marker 222. A marker 222 is preferably only machine readable (such as by applying black light to reveal fluorescence) but not visually distinguishable to a naked eye. The label 22 having thereon the marker 222 may be peelable off the packaging 220, after which it may be placed onto a specimen container that is supposed to contain the specimen of a test taker who was given the pill or capsule P to ingest. A specimen collection authentication system using the pill packaging of FIG. 2 advantageously avoids the need for maintaining a separate chain of custody paper and the need for maintaining a database of coded information.

A label such as label 22 in FIG. 2 preferably is protectively covered, such as by protective cover 23 in FIG. 2A. One example of a protective cover 23 is a tamper-proof cover. Another example of a protective cover 23 is a tamper-evident cover (i.e. one that shows evidence that a person has attempted to view the label under the cover).

In FIG. 3, a specimen container SC (such as a urine specimen container) is subjected (by authorized analytical personnel) to a light source L (such as a black light) with the light source L being selected based on what detectable marker was provided on the label (such as label 22 in FIG. 2) and in the ingestible entity (such as pill or capsule P in FIG. 2). Label 32 in FIG. 3 theoretically should be the same as label 22 in FIG. 2 if indeed the specimen collection proceeded properly. When the black light L is applied to a specimen container SC, is immediately apparent whether either or both of label 32 and specimen S (such as urine) fluoresce or not. If the ingestible entity given to the test-taker to ingest was a placebo, then both the specimen S and the label 32 should lack fluorescence. If the ingestible entity given to the test-taker to ingest included at least one detectable marker, then both the specimen S and the label 32 should fluoresce correspondingly. In a case where a mismatch is observed between fluorescence (if any) between the specimen S and the label 32, then the specimen collection cannot be validated. As noted above, markers that have other detectable properties other than fluorescence might also be used in the practice of the invention.

The scheme depicted in FIG. 2 might alternatively be practiced with coded information on the label 22 in a manner similar to that described with the coded information discussed in connection with FIG. 1.

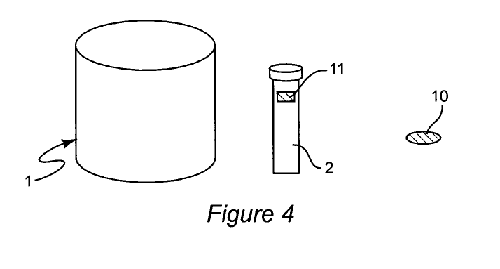

FIG. 4 depicts a specimen container 1 such as might be used to collect a urine specimen for substance use testing. Specimen container 1 initially may be the outer container of the kit, and then may be used for receiving the collected specimen. Sample tube 2 has a tightly sealing cap and bears a label 11 with coded or hidden information about the nature of the ingestible entity 10, which label 11 preferably is tamper-resistant or tamper-evident. The ingestible entity 10 is either a placebo or contains at least one detectable marker.

The present invention provides for randomizing use of a marker (such as, e.g., a chemical marker) under conditions where the subject from whom a specimen is desired to be collected is withheld information about whether s/he is ingesting marker or placebo. That is, the subject is required to ingest an ingestible entity 10 (which is shown for illustration as a pill, capsule or tablet in FIG. 4 but is not necessarily limited to that form) but the ingesting subject is not told what he is or is not ingesting.

Most preferably, information about the identity of the ingestible entity 10 also is withheld from a person giving the subject the ingestible entity 10. Also most preferably, personnel involved with specimen collection and/or in the chain of custody of the collected specimen lack information about the identity of the ingestible entity 10.

Examples of a specimen with which the inventive products, methods and systems may be used are, e.g., urine, blood, saliva, other bodily fluid, cheek swab, etc.

Examples of detectable markers that may be used are, e.g., riboflavin; p-amino benzoic acid; compounds containing non-radioactive isotopes detectible in a urine sample; a compound that is reasonably safe to ingest and detectable (or yield detectable metabolites) in urine; etc. When the ingestible substance comprises a marker, the ingestible substance is not limited to containing one marker, and a randomization scheme optionally may include alternative ingestible substances containing various markers or combinations of markers. Preferably, the identity of the ingestible entity 10 is further randomized or additionally randomized, i.e., involves multiple markers being present or absent.

Riboflavin (Vitamin B2) is a preferred marker for use in the invention because of its advantages, namely, riboflavin (1) is relatively inexpensive; (s) is easily detected in urine (e.g., with the use of a handheld UV light); and (3) is a vitamin essential to normal human physiological processes and is non-toxic over a wide range of concentrations.

Where mentioned herein, a “placebo” means a substance that does not alter the physical/chemical properties of the specimen being taken, such as a urine specimen.

Again referring to FIG. 4, it will be appreciated that for practicing the present invention of randomization of the ingestible entity 10, the specimen tube 2 should have securely affixed thereon a chain of custody label 11, which label 11 preferably is securely affixed to the specimen container 1 by the personnel supplying the ingestible entity 10 to the subject, with the secure affixing preferably occurring before the specimen is received into the specimen container 1 and tube 2. Preferably, the label 11 is coded such as bar coded so as to fail to supply information to the subject and unauthorized personnel in the chain of custody. Also preferably, the label 11 is a two-part tamper-resistant label that originated as a peel-off label from packaging of the ingestible entity 10.

The methods, systems and products of the present invention may be used in any situation in which testing of urine specimens (or other specimens) for the presence of illicit substances is being, or will be, performed, such as, e.g., testing certain employees of businesses/agencies that provide transportation services, pre-employment screening, drug abuse treatment and monitoring programs, screening of athletes, etc.

The invention may be appreciated with regard to the following Example, without the invention being limited to those Examples.

### EXAMPLE 1

By the method of this inventive Example 1, an individual from whom a urine specimen is desired to be received for testing is prevented from introducing a previously obtained urine specimen. Advantageously, urine drug screening of a specimen belonging to an intended test subject may be accomplished, while minimizing intrusion on an individual's privacy. The minimization of intrusion on an individual's privacy may particularly be appreciated in terms of applying the inventive method to a population of individuals, as to the “innocent” individuals who are not attempting specimen substitution.

The inventive method of Example 1 is as follows.

The subject being required to provide a fresh urine specimen is given a “chain of custody” form. Attached to, or associated with, the chain of custody form is an ingestible substance, such as an ingestible substance in the form of a pill, a capsule, a liquid, etc.

The ingestible substance contains either (a) a chemical marker that is detectible, by an authorized laboratory worker, in the urine, or (b) a placebo containing no such marker. The subject from whom the specimen is desired and the collector/collection site are blind to the nature of the ingestible substance. An example of a marker is, e.g., riboflavin, such as 100-200 mg (preferably 150 mg) riboflavin per capsule.

The chain of custody form contains information (e.g., a bar code) that informs the laboratory testing site as to whether or not the subject received marker or placebo.

The subject is required to ingest the ingestible substance prior to being requested to provide a urine specimen. This step of requiring the subject to ingest the ingestible substance is witnessed.

After a predetermined time (such as, e.g., one-two hours), the subject is given a specimen cup, labeled with a replicate bar code and requested to provide a urine specimen. This step of the subject's providing a urine specimen is not required to be witnessed.

Thus, according to the method of Example 1, the subject is randomly given an ingestible substance comprising a marker or placebo capsule. While the subject is informed that s/he will be given a capsule that may contain a marker, the subject is blind to whether the capsule does in fact contain the marker. Therefore, the likelihood of detecting a substituted urine is increased, even without the use of an individual witnessing the subject provide the specimen. (It should be appreciated that witnessing the subject provide the specimen is conventionally in use as a standard protocol.)

To practice the inventive method of Example 1, when the specimen is being analyzed by authorized personnel, it should be appreciated that relationship between the ingestible substance (i.e., active label or placebo) and the presence or absence of label in the urine specimen gives a strong indication of whether or not the subject provided a fresh urine specimen and whether or not another urine specimen was substituted. For making the analytical determination, the analyzing personnel relies upon the personal data entered by the person administering the test. That is, in the process of giving the subject the ingestible substance (such as, e.g., a pill or capsule), the person administering the test entered personal data about the subject on the chain of custody form that had a bar code with information about, among other things, the nature of the ingestible substance. The analyzing personnel has access to this personal information, and to the replicate code attached to the specimen cup into which the subject urinated.

For example, in a scenario where the subject (without being told what he is ingesting) has ingested 150 mg of riboflavin 1.5 to 2 hours before providing a urine specimen, the analyzing personnel see from the bar code on the form and the bar code on the specimen cup that the subject was given that marker to ingest. If the urine specimen contains riboflavin, it would fluoresce when exposed to a black light or ultra violet light. The fluorescent urine specimen would confirm that the subject had ingested the riboflavin prior to providing the urine specimen.

However, if someone other than the subject who ingested the 150 mg of riboflavin before providing a urine specimen, actually provides the urine specimen into the specimen container with the chain of custody form and bar code indicating that the subject was given marker, then the specimen is unlikely to fluoresce when exposed to a black light or ultra violet light, and the substitution is likely to be exposed by the non-fluorescence.

### EXAMPLE 1A

The inventive method of Example 1 may be modified to introduce further randomization. The ingestible substance, such as a pill or capsule, may contain one of several known markers, further increasing the likelihood of detecting a substituted urine specimen.

In inventive Examples 1 and 1A, the fact that the subject who is the intended source of the specimen is not given knowledge in advance whether s/he is ingesting at least one chemical marker (and, if so, which marker or combination of markers) or the placebo provides protection against specimen substitution.

### EXAMPLE 2

The ingestible substance (such as, e.g., a pill or capsule, etc.) may be in a package attached to the chain of custody form.

### EXAMPLE 2A

In another embodiment of the invention, the ingestible substance (such as, e.g., a pill, a capsule, etc.) is in an individual package. In this Example 2A, the packaging for the ingestible substance has a peel-off sticker on it. A preferred example of the peel-off sticker, e.g., comprises two layers that peel off the packaging (containing the to-be-ingested ingestible substance) as a single unit. The upper layer preferably is a tamper-resistant material that itself could be peeled-off a lower layer. The lower layer, on packages containing the marker (such as, e.g., a riboflavin capsule), preferably fluoresces when exposed to the same wavelengths of light that cause the riboflavin in the urine to fluoresce.

Packages containing ingestible placebo preferably have a sticker with a lower layer that does not fluoresce when exposed to wavelengths of light that would cause riboflavin in urine to fluoresce. The tamper-resistant upper layer does not fluoresce when exposed to this light and would block the light from reaching the lower layer so the entire sticker unit does not fluoresce when exposed to such light.

### EXAMPLE 3

A person administering a substance use test gives the subject an ingestible substance (such as, e.g., preferably from a bottle containing a mixture of active label capsules and placebo capsules).

Preferably the ingestible capsules are contained in a container having a two-part peel-off sticker as in Example 2A. The administrator peels off the sticker unit from the container that is the source of the capsule, and attaches the sticker to the surface of the urine specimen cup. The person administering the test does not remove the tamper-resistant upper layer of the sticker. The subject, 1.5 to 2 hours after having taken the capsule, is requested to provide a urine specimen in the specimen cup that is thus-stickered.

The specimen cup is transmitted to an analytical facility. At the facility analyzing the urine specimen, the person conducting the analysis peels away the upper layer and exposes the lower layer of the sticker and the urine in the specimen cup to black light or ultra violet light. If both the lower layer of the sticker and the urine in the cup fluoresce, or if neither the lower layer of the sticker and the urine in the cup fluoresce, the person analyzing the urine specimen may assume the specimen was not substituted, and represents an authentic fresh specimen from the intended subject. However, if the lower layer of the sticker fluoresces and the urine specimen does not, or if the lower layer of the sticker does not fluoresce and the urine specimen does, the person analyzing the specimen may assume the specimen may not be fresh and the urine test would be declared invalid.

When a urine test is declared invalid in the practice of the present invention, the subject may be required, for example, to make arrangements to give a witnessed urine specimen.

The purpose of the tamper-resistant layer in this Example is to prevent the subject from secretly determining whether or not the sticker was fluorescent, thereby allowing the subject to substitute a urine specimen that matches the sticker. The tamper-resistant layer also prevents the person administering the test from covertly determining whether or not the sticker was fluorescent and passing the information onto the subject, who in turn could then substitute a matching urine specimen. If the tamper-resistant upper layer appears damaged when received by the person analyzing the specimen, the urine test would be declared invalid.

### EXAMPLE 4

A study was conducted in which volunteers ingested, in blind fashion, 150 mg of riboflavin or placebo and provided a urine specimen both 1.5 hours and 24 hours later. Reviewers, blinded to what the subjects had ingested, independently determined whether or not the urine specimen fluoresced. The results indicated a high degree of sensitivity and specificity.

Although there have been many examples herein for urine specimens, it should be appreciated that the invention is not limited to urine specimens and may be used for other biological specimens.

While the invention has been described in terms of its preferred embodiments, those skilled in the art will recognize that the invention can be practiced with modification within the spirit and scope of the appended claims.

What we claim as our invention is:

1. A method for assuring urine or biological specimen authenticity while providing individual privacy, comprising the steps of:
providing to an individual from which a urine or biological specimen is to be procured an ingestible entity which is of a nature that is either a placebo or at least one detectable marker, said providing step being performed in a manner where neither a provider or the individual receiving the ingestible entity is aware of its nature;
providing a mechanism for associating said nature of said ingestible entity with said individual that is provided said ingestible entity in said providing step whereby neither the provider nor the individual receiving the ingestible entity is aware of the nature of the ingestible entity from the mechanism for associating;
confirming that the individual from which the urine specimen is to be procured ingests the ingestible entity; and then
obtaining a urine specimen from the individual from which the urine specimen is to be procured; and then
determining the authenticity of the urine specimen by
detecting the presence or absence of said detectable marker in the urine specimen, and by
determining from said mechanism for associating whether the ingestible entity ingested by the individual was a placebo or a detectable marker,
said step of determining being performed by a testing authority different from said provider.

2. The method of claim 1 wherein said ingestible entity is a pill or a capsule.

3. The method of claim 1 wherein said ingestible entity is a fluid.

4. The method of claim 1 wherein said detectable marker is selected from the group consisting of riboflavin; p-amino benzoic acid; a compound containing at least one non-radioactive isotope detectible in a urine sample; a compound that is reasonably safe to ingest and detectable in urine; and, a compound that is reasonably safe to ingest and yields detectable metabolites in urine.

5. The method of claim 1 wherein said detectable marker is riboflavin (Vitamin B2).

6. The method of claim 1 wherein said mechanism for associating is a chain of custody form which includes coded information that describes the nature of the ingestible entity,
wherein said step of determining from said mechanism for associating whether the ingestible entity ingested by the individual was a placebo or a detectable marker includes the step of determining the nature of the ingestible entity from said coded information,
and wherein said ingestible entity is affixed to said chain of custody form prior to said providing to an individual step.

7. The method of claim 6 wherein said coded identification information is a bar code.

8. The method of claim 6 wherein said coded information is an RFID tag.

9. The method of claim 6 wherein said chain of custody form includes a label of coded information which is removable from said chain of custody form and affixable to a container(s) used by said individual when collecting said urine specimen which is identical to said coded information on said chain of custody form, and further comprising the steps of:
removing the label of coded information from said chain of custody form; and
affixing the label of coded information to said container.

10. The method of claim 1 wherein said mechanism for associating includes a label that is attached to packaging containing said ingestible entity, said label having either a detectable marker identical to said at least one detectable marker in said ingestible entity thereon or having no detectable marker thereon, whereby said step of determining from said mechanism for associating whether the ingestible entity ingested by the individual was a placebo or a detectable marker, includes the step of determining the presence or absence of said detectable marker on said label.

11. The method of claim 10 wherein said label is in the form of a removable sticker which can be affixed to a container which said individual will use for collecting and/or transporting said urine specimen.

12. The method of claim 10 wherein said label includes a removable cover which prevents determining the nature of the label by either said provider or said individual.

13. The method of claim 12 wherein said removable cover is tamper resistant.

14. The method of claim 12 wherein said removable cover is tamper evident.

15. The method of claim 1 wherein said mechanism for associating includes a label that is attached to packaging containing said ingestible entity, said label having coded information that describe the nature of the ingestible entity, and
wherein said step of determining from said mechanism for associating whether the ingestible entity ingested by the individual was a placebo or a detectable marker includes the step of determining the nature of the ingestible entity from said coded information on said label.

16. The method of claim 15 wherein said label is in the form of a removable sticker which can be affixed to a container(s) which said individual will use for collecting and/or transporting

17. The method of claim 15 wherein said label includes a removable cover which prevents determining the nature of the label by either said provider or said individual.

18. The method of claim 17 wherein said removable cover is tamper resistant.

19. The method of claim 17 wherein said removable cover is tamper evident.

20. The method of claim 1 further comprising the step of providing ingestible entities which includes one of a plurality of different chemical markers.
